(19) United States
(12) Patent Application Publication
(10) Pub. No.: US 2007/0158584 A1
(43) Pub. Date: Jul. 12, 2007

(54) HEAT SINK WITH CARBON NANOTUBES AND METHOD FOR MANUFACTURING THE SAME

(75) Inventor: MONG-TUNG LIN, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,531

(22) Filed: Aug. 18, 2006

(30) Foreign Application Priority Data
Nov. 11, 2005 (CN) 200510101199.8

(51) Int. Cl. G01F 23/00

(52) U.S. Cl. 250/441.11

(57) ABSTRACT

A heat sink includes a base and a plurality of carbon nanotubes. The base has a first surface and a second surface facing away from the first surface. The carbon nanotubes each have a main portion and a distal portion. The distal portion is embedded in the base and extends from the first surface to the second surface of the base, the main portion extends from the second surface in a direction away from the first surface of the base. The heat sink with a small volume has a large heat dissipating area, and, accordingly, has better heat dissipation.

### FIELD OF THE INVENTION

The present invention relates generally to heat sinks, and more particularly to a heat sink with carbon nanotubes and a method for manufacturing the heat sink.

### DESCRIPTION OF RELATED ART

Electronic components such as semiconductor chips are becoming progressively smaller, while at the same time heat dissipation requirements thereof are increasing.

MOSFET stands for metal oxide semiconductor field effect transistor and is the most important component for CPU (central processing unit) voltage regulation on a motherboard. These voltage regulators using MOSFETs provide voltage to the CPU. The quality and number of MOSFETs directly affect the performance of the CPU. Needless to say, higher quality MOSFETs produce better voltage regulation. The number of MOSFETs determines the number of power phases. More phases are better than fewer phases as the regulators can split the workload and thus run at a cooler temperature. However, there are cases where higher power is sometimes required and larger capacitors are employed in the voltage regulator, which leads to an increase in the temperature of the MOSFETs. The temperature of the MOSFETs can reach as high as 125oC. In order to ensure stability of the CPU, the MOSFETs should have lower operating temperatures and this requires heat dissipation. Heat sinks can promote heat dissipation in the MOSFETs, but conventional heat sinks made of aluminum or copper are too big to be used for cooling the MOSFETs used in voltage regulators.

What is needed, therefore, is a heat sink with smaller volume and better heat dissipation.

### SUMMARY OF INVENTION

In accordance with one embodiment, a heat sink includes a base and a plurality of carbon nanotubes. The base has a first surface and a second surface facing away from the first surface. The carbon nanotubes each have a main portion and a distal portion. The distal portion is embedded in the base and extends from the first surface to the second surface of the base, the main portion extends from the second surface in a direction away from the first surface of the base.

In accordance with another embodiment, a method for manufacturing a heat sink includes the steps of: providing a substrate; forming a plurality of carbon nanotubes on the substrate; forming a base to embed end portions of the carbon nanotubes, where the carbon nanotubes extend from the substrate; and removing the substrate.

In accordance with yet another embodiment, a heat sink includes a polymer base sheet and a plurality of carbon nanotubes. The polymer base sheet has a first surface and a second surface facing away from the first surface. The carbon nanotubes each have a first portion and a second portion. The first portion is arranged outside the polymer base sheet, the second portion is embedded in the polymer base sheet and extends from the second surface to the first surface of the base sheet and substantially terminates at the first surface.

Other advantages and novel features will become more apparent from the following detailed description of present heat sink and method relating thereto, when taken in conjunction with the accompanying drawings.

### BRIEF DESCRIPTION OF THE DRAWINGS

Many aspects of the present heat sink and method relating thereto can be better understood with reference to the following drawings. The components in the drawings are not necessarily drawn to scale, the emphasis instead being placed upon clearly illustrating the principles of the present heat sink and method relating thereto. Moreover, in the drawings, like reference numerals designate corresponding parts throughout the several views.

FIG. 1 is a schematic, cross-sectional view of a heat sink according to an embodiment of the present heat sink;

FIG. 2 is a flow chart of a method for manufacturing the heat sink of FIG. 1 according to another embodiment of the present heat sink;

FIG. 3 is a schematic side view showing one stage of the method of FIG. 2, namely, a substrate being provided;

FIG. 4 is similar to FIG. 3, but showing carbon nanotubes formed on the substrate;

FIG. 5 is similar to FIG. 4, but showing a base being formed; and

FIG. 6 is a similar to FIG. 5, but showing the substrate being removed.

### DETAILED DESCRIPTION

Embodiment of the present heat sink will now be described in detail below and with reference to the drawings.

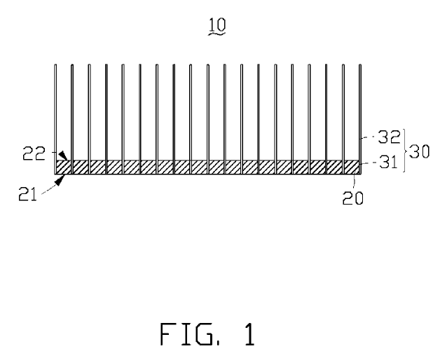

Referring to FIG. 1, a heat sink 10 according to an embodiment includes a base 20 and a plurality of carbon nanotubes 30. The base 20 has a first surface 21 and a second surface 22 facing away from the first surface 21. The carbon nanotubes 30 each have a main portion 32 and a distal portion 31, the distal portion 31 is embedded in the base 20 and extends from the first surface 21 to the second surface 22 of the base 20, the main portion 32 extends from the second surface 22 in a direction away from the first surface 21 of the base 20.

The base 20 can be made of a polymer material. The polymer material can be selected from the group consisting of silicone rubber, polyester, polyvinyl chloride, polyvinyl alcohol, polyethylene, polypropylene, epoxy resin, polyformaldehyde, polyacetal, and any combinations thereof. Generally, the thickness of the base 20 is in the range from 0.1 to 2 millimeters.

The carbon nanotubes 30 can be a carbon nanotube array or a carbon nanotube bundle array. The carbon nanotubes 30 are orientated at an angle substantially perpendicular to the base 20. The extremities of the distal portions 31 of the carbon nanotubes 30 are exposed at the first surface 21. The length of the carbon nanotubes 30 is determined by the thickness of the base 20 and the space to assemble it in the actual application. Generally, the length of the carbon nanotubes 30 is in the range from 1 to 5 millimeters. Every carbon nanotube bundle contains a plurality of carbon nanotubes, the space between adjacent carbon nanotube bundles is in the range from 0.1 to 1 millimeters.

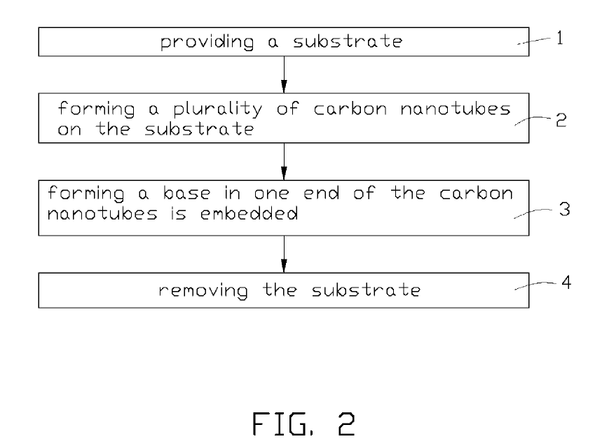

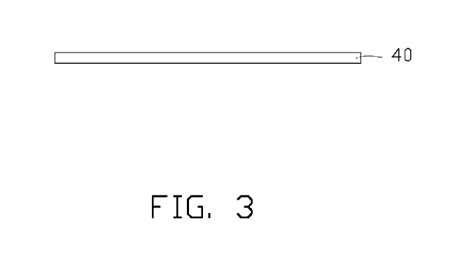

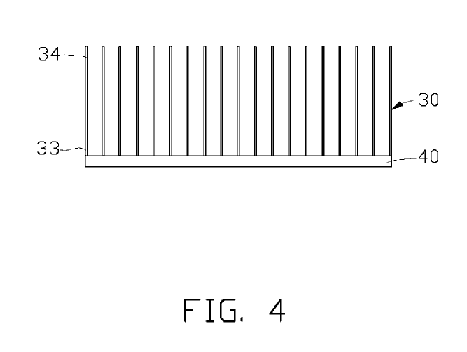

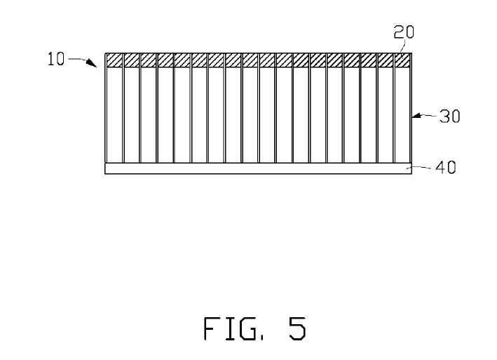

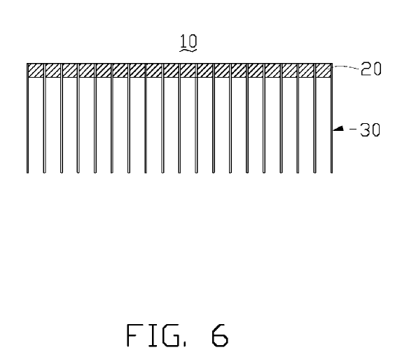

Referring to FIG. 2 to FIG. 6, a method for manufacturing the heat sink 10 according to an embodiment includes the following steps:

step 1: providing a substrate 40;

step 2: forming a plurality of carbon nanotubes 30 on the substrate 40;

step 3: forming a base 20 in which one end of the carbon nanotubes 30 is embedded; and

step 4: removing the substrate 40 and obtaining the heat sink 10.

The substrate 40 can be made of a material selected from the group consisting of glass, silicon, metal and any oxides thereof. In present embodiment, the substrate 40 is made of silicon. A surface of the substrate 40 can be polished to form the carbon nanotubes 30 thereon.

In present embodiment, the carbon nanotubes 30 on the substrate 40 are formed by way of chemical vapor deposition. First, a catalyst film is deposited on the surface of the substrate 40, the catalyst film can include a material selected from the group consisting of iron, cobalt, nickel, palladium and any alloys thereof. In order to form a carbon nanotube bundle array on the substrate 40, the catalyst film can be formed in a pattern. The substrate 40 can then be placed in a reaction furnace, and a carbon source gas can be injected into the reaction furnace at a temperature of 700 to 1000 degrees centigrade in order to grow the array of carbon nanotubes 30 by way of low temperature chemical vapor deposition. The carbon nanotubes 30 are orientated parallel to each other and substantially perpendicular to the substrate 40. The length of the carbon nanotubes 30 is in the range from 1 to 5 millimeters.

In step 3, the carbon nanotubes 30 have a first end 33 connected with the substrate 40 and a second end 34 extending away from the substrate 40. The base 20 can be formed at the first end 33 or at the second end 34. The base 20 can be formed at the first end 33 of the carbon nanotubes 30 by injecting melted polymer material or prepolymer material solution around the first end 33 and then converting the melted polymer material or the prepolymer solution from a liquid state to a solid state. The base 20 can be formed at the second end 34 of the carbon nanotubes 30 by immersing the second end 34 of the carbon nanotubes 30 in a melted polymer material or a prepolymer solution, and forming the base by converting the melted polymer material or the prepolymer solution from a liquid state to a solid state. The polymer material can be selected from the group consisting of silicone rubber, polyester, polyvinyl chloride, polyvinyl alcohol, polyethylene, polypropylene, epoxy resin, polyformaldehyde, polyacetal, and any combinations thereof. In present embodiment, the base 20 is formed at the second end 34 of the carbon nanotubes 30 by immersing the second end 34 in a melted polyvinyl alcohol. The thickness of the base 20 is determined by the depth to which the carbon nanotubes 30 are immersed in the melted polymer material. The thickness of the base 20 can be in the range from 0.1 to 2 millimeters. In present embodiment, the thickness of the base 20 is 0.8 millimeters.

In step 4, chemical etching or mechanical grinding can be used to remove the substrate. In present embodiment, mechanical grinding should preferably be used to remove the substrate 40.

The heat sink 10 of the present invention includes a base 20 and a plurality of carbon nanotubes 30, the carbon nanotubes 30 function like fins of the heat sink. As the diameter of the carbon nanotubes 30 is nano-sized, the length of the carbon nanotubes 30 is much larger than the diameter of the carbon nanotubes 30. Accordingly, the heat sink 10 with a small volume has a larger heat dissipating area, and has better heat dissipating.

It is understood that the above-described embodiment is intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A heat sink, comprising:
a base having a first surface and a second surface facing away from the first surface; and
a plurality of carbon nanotubes each having a main portion and a distal portion, the distal portion being embedded in the base and positioned from the first surface to the second surface of the base, the main portion extending from the second surface in a direction away from the first surface of the base.

2. The heat sink as claimed in claim 1, wherein the base is comprised of a polymer material.

3. The heat sink as claimed in claim 2, wherein the polymer material is selected from the group consisting of silicone rubber, polyester, polyvinyl chloride, polyvinyl alcohol, polyethylene, polypropylene, epoxy resin, polyformaldehyde, polyacetal, and any combination thereof.

4. The heat sink as claimed in claim 1, wherein the base has a thickness in a range from 0.1 to 2 millimeters.

5. The heat sink as claimed in claim 1, wherein the carbon nanotubes form a carbon nanotube array.

6. The heat sink as claimed in claim 1, wherein the carbon nanotubes form a carbon nanotube bundle array.

7. The heat sink as claimed in claim 6, wherein the space between adjacent carbon nanotube bundles is in a range from 0.1 to 1 millimeters.

8. The heat sink as claimed in claim 1, wherein the carbon nanotubes are substantially perpendicular to the base.

9. The heat sink as claimed in claim 1, wherein extremities of the distal portions of the carbon nanotubes are exposed at the first surface.

10. The heat sink as claimed in claim 1, wherein the carbon nanotubes have a length in a range from 1 to 5 millimeters.

11. A method for manufacturing a heat sink, comprising the steps of:
providing a substrate;
forming a plurality of carbon nanotubes on the substrate;
forming a base to embed one end of the carbon nanotubes; and
removing the substrate.

12. The method for manufacturing a heat sink as claimed in claim 11, wherein the substrate is made of a material selected from the group consisting of glass, silicon, metal and any oxides thereof.

13. The method for manufacturing a heat sink as claimed in claim 11, wherein a surface of the substrate is polished for forming the carbon nanotubes thereon.

14. The method for manufacturing a heat sink as claimed in claim 11, wherein the step of forming the base comprises the steps of immersing the end portions of the carbon nanotubes that are distal from the substrate in either a melted polymer material or a prepolymer solution, and forming the base by converting the melted polymer material or the prepolymer solution from a liquid state to a solid state.

15. The method for manufacturing a heat sink as claimed in claim 11, wherein the substrate is removed by chemical etching or mechanical grinding.

16. A heat sink comprising:
a polymer base sheet having a first surface and a second surface facing away from the first surface; and
a plurality of carbon nanotubes each having a first portion and a second portion, the first portion being arranged outside the polymer base sheet, the second portion being embedded in the polymer base sheet and extending from the second surface to the first surface of the base sheet and substantially terminating at the first surface.

17. The heat sink as claimed in claim 16, wherein the carbon nanotubes have substantially the same length.

18. The heat sink as claimed in claim 16, wherein the carbon nanotubes are orientated at an angle substantially perpendicular to the polymer base sheet.
